(19) United States
(12) Patent Application Publication
(10) Pub. No.: US 2017/0117630 A1
(43) Pub. Date: Apr. 27, 2017

(54) SINGLE LOOP NEAR FIELD COMMUNICATIONS ANTENNA

(71) Applicant: Microsoft Technology Licensing, LLC, Redmond, WA (US)

(72) Inventor: Juha Petri Mikael Lilja, Tampere (FI)

(21) Appl. No.: 14/918,901

(22) Filed: Oct. 21, 2015

(51) Int. Cl. H01Q 7/00; H01Q 1/50; H01Q 1/24

(52) U.S. Cl. CPC H01Q 7/00; H01Q 1/24; H01Q 1/50

(57) ABSTRACT

A near field communications antenna is described, the antenna comprising a single conductive loop connected to a transformer, the single conductive loop being a loop without a plurality of turns or coils. In some examples there is a method of operation of a near field communications antenna comprising applying power to a transformer which is connected to a single conductive loop, the single conductive loop being a loop without a plurality of turns or coils, such that a magnetic field generated in the transformer transforms the impedance of the single conductive loop into a range suitable for near field communications.

### BACKGROUND

Near field communication (NFC) uses magnetic induction between two loop antennas, one in a mobile communications device for example, and another in a second device which may or may not be powered. When the two devices are within physical proximity of one another, so the loop antenna of one device is within the magnetic field of the other device then NFC communications may be established between the devices. NFC operates at 13.56 MHz on ISO/IEC 18000-3 air interface and at rates ranging from 106 kbits/s to 424 kbits/s.

Near field communications antennas are typically relatively large as compared with other antennas in hand held or portable communications devices. Typically they comprise a coil with several turns of conductor.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A near field communications antenna is described comprising a conductive loop connected to a transformer, the conductive loop having only one loop.

In some examples there is a method of operation of a near field communications antenna comprising applying power to a transformer which is connected to a single conductive loop, the single conductive loop being a loop without a plurality of turns or coils, such that a magnetic field generated in the transformer transforms the inductance of the single conductive loop into a range suitable for near field communications.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a mobile communications device having a single loop NFC antenna used for NFC communication with one or more other NFC devices;

FIG. 2 is a schematic diagram of a back cover of a mobile communications device with a single loop NFC antenna, and showing communication with another NFC device;

FIG. 3 is an exploded view of a front and back cover of a metal computing device case having a single loop NFC antenna in a side face of the back cover;

FIG. 4 illustrates an example side face single loop NFC antenna assembly with a side face notch and a plastic insert;

FIG. 5 is a graph of coupling performance of a single loop NFC antenna with respect to a second NFC antenna, for different transformers;

FIG. 6 is a Smith diagram illustrating shift of impedance of a single loop NFC antenna as a result of adding a transformer;

FIG. 7 is a schematic diagram of a transformer showing a primary and a secondary transformer coil;

FIG. 8 illustrates an exemplary communications device comprising one or more antennas.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Examples herein describe a new compact NFC antenna which is suitable for integration in a metal computing device case. By using a transformer connected to a single loop antenna, it has been found that the resulting antenna gives good NFC communication whilst being compact, and if desired, integrated in a metal structure such as a metal computing device case by using a slot or other aperture in the metal computing device case. Previous single loop antennas are typically unusable for NFC as they are unable to generate a strong enough magnetic field.

Various different types of transformer may be used where these act to move the impedance of the single loop antenna into a range suitable for NFC communication. A non-exhaustive list of examples of suitable transformer is: surface mount transformer, toroid transformer, coupled transformer coils etched on printed wiring board layers. The transformer comprises a primary coil of conductor and a secondary coil of conductor. The transformer is magnetic in that the coils are configured so that a magnetic connection between the primary and secondary coils is made when current flows through the coils.

In some examples the single loop antenna is a closed loop comprising a continuous loop of conductor, although this is not essential. For example, the loop may be formed by the sides of a slot or aperture in a metal computing device case and a transformer connected to the slot or aperture. Using a closed loop enables a continuous current connection around the loop which acts almost as a short circuit at the NFC frequency. The closed loop can be integrated into a metal computing device case in a compact manner, even where the metal computing device case comprises other antennas used for other types of wireless communications. For example, the location of the transformer can be chosen independently of the location of a slot or aperture used to form the loop antenna.

Near field communication (NFC) uses magnetic induction between two loop antennas, one in a mobile communications device for example, and another in a second device which may or may not be powered. This is also referred to as magnetic near field coupling. Where the second device is not powered (referred to as passive communication mode) it may be provided in a simple form factor such as a tag, sticker, key fob or other passive device. In passive communication mode the initiator device creates a carrier magnetic field and the target device answers by modulating the existing magnetic field. For example, the target device may draw its operating power from the magnetic field generated by the initiator device.

NFC peer to peer communication may occur in cases where both loop antennas are powered. In this situation, referred to as active communication mode, both the initiator and target device communicate by alternately generating their own magnetic fields. When waiting for data a device deactivates its magnetic field.

Where two entities communicate using NFC communications they are physically proximate to one another as mentioned above. For example, touching or within about 20 cm of one another. Communication protocols and data exchange formats for NFC are set out in ISO/IEC 18092 and those defined by the NFC Forum.

As mentioned above previous single loop antennas are typically unusable for NFC as they are unable to generate a strong enough magnetic field. It is recognized herein that the strength of magnetic field that is generated by a loop antenna is dependent on at least the following factors: the number of turns in the coil (a loop antenna typically comprises a coil), the surface area of the antenna, the current fed to the antenna, and losses generated by the antenna traces, matching circuit and the environment where the antenna is placed. The distance between two entities using NFC is already very small and so it is not practical to try to reduce this distance further (by using poorer NFC antennas).

The ability of an NFC antenna to generate a magnetic field may be measured as the inductance of the NFC antenna. However, in the examples described herein, the inductance of the NFC antenna is different from the inductance seen by matching circuit (which matches the inductance of the loop antenna to NFC circuitry). This is explained in more detail below.

Previous NFC antennas have used several turns of conductor to form a coil and have typically added a ferrite sheet next to the antenna in order to increase the magnetic field strength. For example, a previous NFC antenna uses several turns of conductor trace in order to reach an antenna inductance of the order of 1 to 2 μH. This is typically reached using a coil having 3 to 5 turns of conductor and a ferrite sheet next to the antenna.

These previous NFC antennas are not suited for integration in metal computing device cases where those metal computing device cases have slots used by other antennas such as cellular, GPS or WLAN antennas. This is because a conventional NFC antenna degrades the performance of the other antennas such as cellular, GPS or WLAN because of the physical presence of the conductive coil (and optional ferrite) in the radiating field of the other antennas. This makes it extremely difficult to create an NFC antenna which can be used with other types of antennas in a metal computing device case without degrading the performance of the other antennas. It is also desired where possible to reduce the number of slots and/or apertures in the metal computing device case as this simplifies manufacture, improves robustness of the case and gives greater protection to components inside the case.

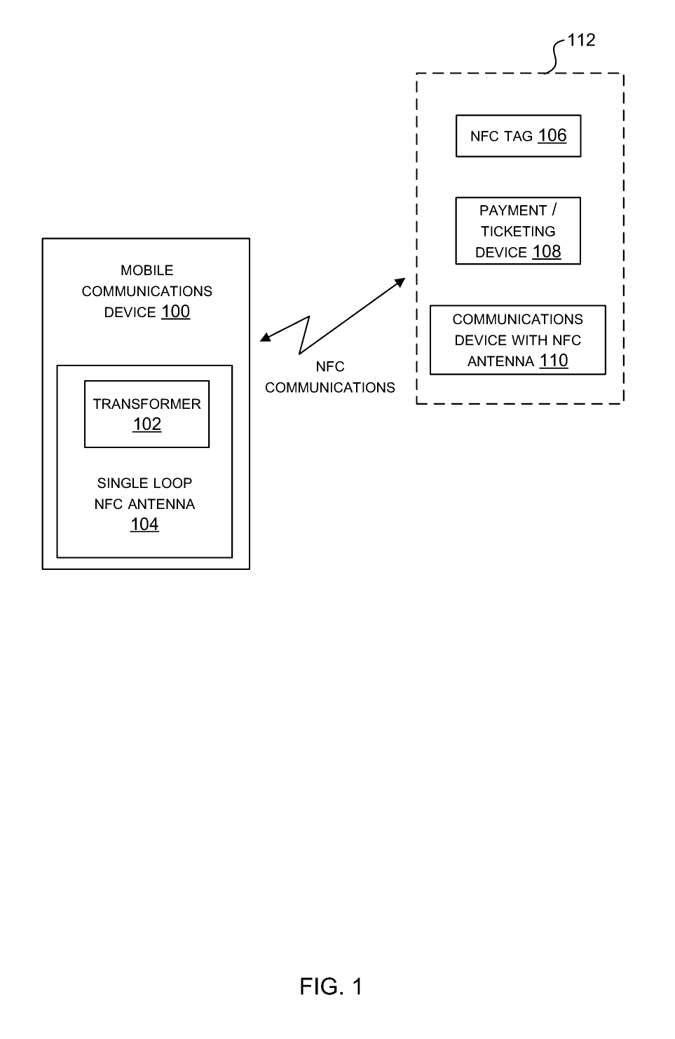

FIG. 1 is a schematic diagram of a mobile communications device 100 having a single loop NFC antenna 104 used for NFC communication with one or more other NFC devices 112. The other NFC devices comprise an NFC tag 106, a payment or ticketing device 108 and a communications device with a powered NFC antenna 110 such as another mobile communications device 100. The NFC tag 106 is an example of a passive NFC antenna as described above. For example, it may be incorporated on the swing tag of a garment in a store so that a customer can move his or her mobile communications device 100 near to the swing tag in order to obtain data encoded in the tag which may be related to the garment.

In another example, the single loop NFC antenna 104 of the mobile communications device 100 is used to emulate a payment card. When the mobile communications device 100 is close enough to the payment/ticketing device 108 a financial transaction may be initiated as a result of NFC communication between the mobile communications device 100 and the payment/ticketing device 108.

In another example, NFC peer to peer communications take place between the communications devices 100, 110, for example, to share data, to facilitate joining one of the devices to a secure wireless communications network of which the other device is already a member, or for other purposes.

The single loop NFC antenna 104 comprises a transformer 102 as described in more detail below. The transformer acts to move the impedance of the single loop conductor into a range suitable for NFC communication from a range which is unsuitable for NFC communication. In the examples described herein the single loop NFC antenna may comprise a closed conductive loop formed by a conductor and a transformer. In some embodiments the conductive loop is formed at least in part by metal or other conductive material of a computing device case. In other examples, the computing device case is plastic and the conductive loop is formed using a printed conductor printed onto the plastic computing device case itself, or printed onto an entity within the computing device case. In other examples, the conductive loop is formed as an etched trace on a flex within the computing device case, where the computing device case is made of plastic or other non-conductive material. Conductive loops formed using combinations of one or more of part of a conductive computing device case, printed conductor, and etched trace may be used.

The mobile communications device 100 may comprise other antennas for other types of wireless communications including but not limited to cellular communications, GPS and WLAN. The mobile communications device 100 may be a smart phone, tablet computer or any other portable and/or hand held communications device. The mobile communications device may have a metal cover, a plastic cover, or a cover made from combinations of metal and plastic or other materials.

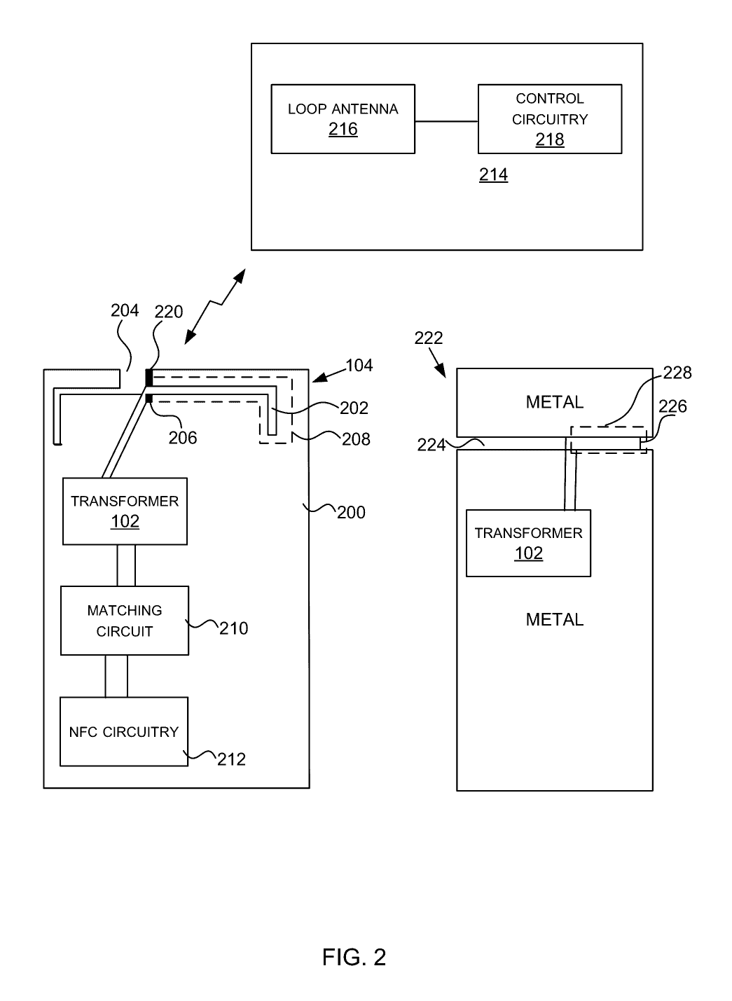

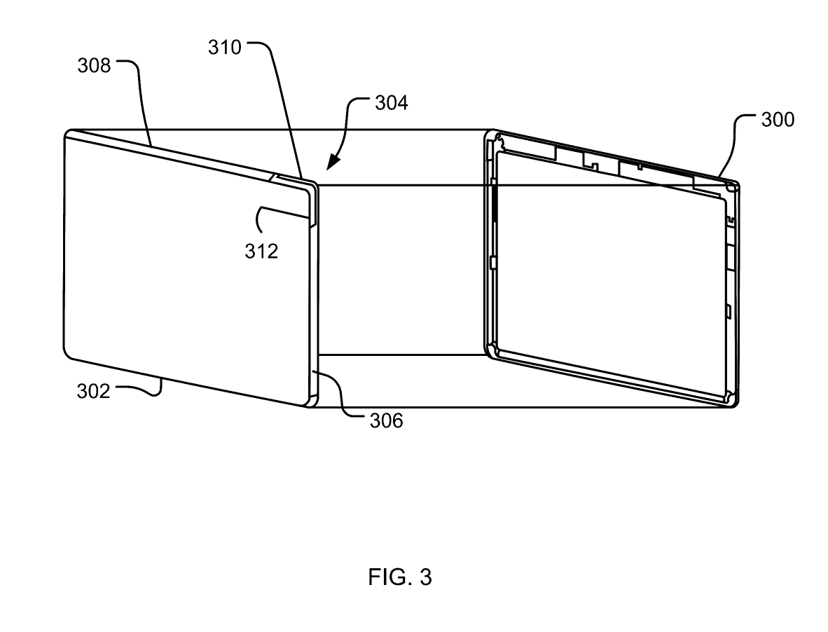

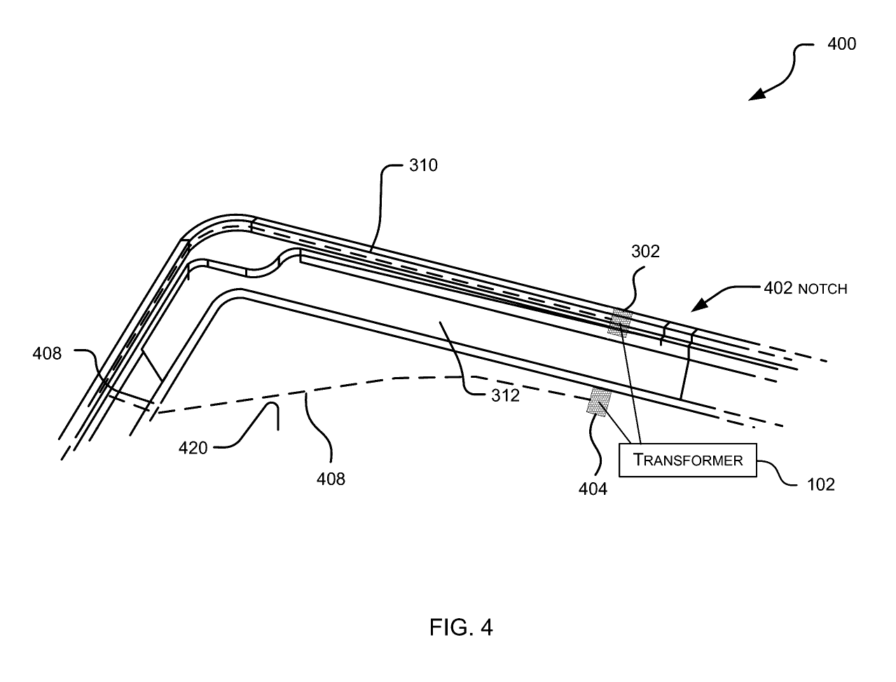

FIG. 2 is a schematic diagram of a back cover 200 of a mobile communications device with a single loop NFC antenna 104, and showing communication with another NFC device 214. In this example, the back cover 200 is made of metal at least in the area around slot 202. The mobile communications device contains at least transformer 102, matching circuit 210 and NFC circuitry 212 which are shown schematically in the diagram. In use, a front cover is attached to the back cover 200 so as to contain the transformer 102, matching circuit 210 and NFC circuitry (as well as other components of the mobile communications device). The front cover may comprise a display screen. In the example of FIG. 2 the back cover 200 is shown as being flat although in practice, edges of the back cover 200 may be perpendicular to the rest of the back cover 200 so as to create sides of the mobile communications device. For example, the single loop NFC antenna may be formed by a slot in two or more sides of the mobile communications device. This is illustrated in FIGS. 3 and 4. Having said that, the single loop NFC antenna may be formed by a slot or aperture at any location in a conductive part of the cover of the mobile communications device.

In the example of FIG. 2 the single loop NFC antenna comprises a single loop formed by conductive sides of a slot 202 in the back cover 200, and a transformer 102 connected to each side of the slot 202. Current flow around the loop formed by the sides of the slot and the transformer 102. The path of the current is indicated by dotted line 208. That is, when power is applied to the antenna, current flows from transformer 102 to a first connection point 206 on the edge of the slot along a conductive connection between the transformer 102 and the connection point. The current flows from connection point 206 along the side of the slot 202 (generally following line 208) until it reaches a second connection point 220 on the edge of the slot and at a mouth of the slot 204. From the second connection point 220 the current flows to the transformer 102 and then back round the loop to connection point 206 and so on. In this example the loop is a closed loop in that the conductor (formed by the edges of the slot and the transformer) is continuous. A closed loop gives a continuous trace, i.e. a direct current connection and this facilitates compactness of the antenna.

The single loop antenna 104 of the first mobile communications device 200 in FIG. 2 is able to carry out near field communications with a second loop antenna 216 in another device 214 which is physically proximate to the first mobile communication device. The second loop antenna 216 may comprise a conventional NFC antenna having a coil of conductor with several turns. In some cases the second loop antenna 216 is a single loop antenna 104 of the new type described herein.

When the single loop NFC antenna of FIG. 2 is not being used, the metal structures formed by slot 202 and mouth 204 may be used as antennas for other types of wireless communications such as cellular, GPS or WLAN communications.

FIG. 2 also shows a back cover 222 of a second mobile communications device. In this case the back cover 222 is metallic and is split into two parts by slot 224. A loop (indicated by dotted line 228) is formed for the NFC antenna by including two contact areas. The first contact area connects a transformer 102 to the metal loop. The second contact area 226 enables a single closed loop to be formed by adding a short circuit or a series inductor.

By using a single loop and a transformer to create an NFC antenna the resulting NFC antenna can be integrated in a smaller space than has previously been possible without sacrificing performance. For example, a single loop NFC antenna is considerably smaller than a conventional NFC antenna with coils of several turns of conductor. Also a significant price reduction is possible because there is no need for a separate NFC antenna since the single loop and transformer may be combined with existing antenna structures in a mobile communications device. In various examples other cellular and/or complementary wireless system (CWS) antennas can be integrated in the same metal device aperture with the NFC antenna without perturbing the performance of the other antennas. In various examples the NFC antenna is not aligned next to the slot in the metal cover in that the transformer may be positioned some distance away from the antenna slot which brings benefits to the printed wiring board design.

FIG. 3 is an exploded view of a front cover 300 and back cover 302 of a metal computing device case having a single loop NFC antenna 304 formed around a corner joining two side faces of the back cover. The front cover 300 is sized and shaped to hold a display screen (not shown) and the back cover 302 is sized and shaped to be held in the palm of a user's hand. The back cover 302 has a back face and four side faces bounding the back face. Two of the side faces 306, 308 are visible in FIG. 3. In this example the back face and the side faces which bound it are integrated in a single piece construction, although other assembled configurations are contemplated.

In this example, the single loop NFC antenna is not fully visible as the transformer and the connections between the single loop antenna and the transformer are hidden from view inside the back cover. However, FIG. 4 shows more detail of another single loop NFC antenna with similar construction.

Referring to FIG. 3 the single loop antenna is formed from one or more apertures or cut-outs created in one or more of the side faces. In this example, the single loop antenna is formed from a cut out 312 in two side faces 306, 308 which abut the same corner of the back cover. The cut out may be air filled, or filled with plastic or other non-conducting material which protects the mobile communications device from moisture, dust and improves robustness of the device. The single loop is formed from the metal sides of the cut out which include arm 310, part of a corner of the back cover 302 around which the cut out extends and also connections to a transformer and the transformer itself which are not visible in FIG. 3.

Referring to FIG. 4 this shows an example side face single loop NFC antenna assembly with a side face notch and a plastic insert. The single loop NFC antenna assembly is the one of FIG. 3 shown in more detail. An L-shaped slot 312 in two side faces of a metal computing device case is filled with a plastic insert. The L-shaped slot has a notch 402 cut in one of the side faces. This forms metal antenna arm 310 extending along part of two side faces of the computing device case, and around a corner of the computing device case. The metal antenna arm 410 has a first transformer connection point 302 proximate to the slot 402. The metal computing device case has a planar face 420 such as the back face of the computing device case. The planar face comprises a second transformer connection point 404. In this example the second transformer connection point is opposite the first transformer connection point although this is not essential. A transformer 102 is supported inside the metal computing device case and connected to the first and second connection points.

A single loop NFC antenna is formed when power is fed to the transformer 102 such that current flows around a loop from the first connection point 302 along the antenna arm 310 onto the back face of the computing device case 420 and to the second connection point. This current path is illustrated by a dotted line 408 in FIG. 4.

It is understood that other configurations of any one or more of slots, apertures, cut-outs, notches may be used to obtain a single loop antenna in a computing device case, where at least part of the computing device case is metal or made of other conducting material.

When the single loop NFC antennas of FIGS. 3 and 4 are not being used for near field communications, the metal structures formed by the slots 312, and notch 402 may be used as antennas for other types of wireless communications such as UMTS, GSM, LTE, 4G, 3G, 2G, WiFi (trademark), WiMAX (trademark), Bluetooth (trademark), Miracast (trademark) and other standards or specifications that may be developed in the future.

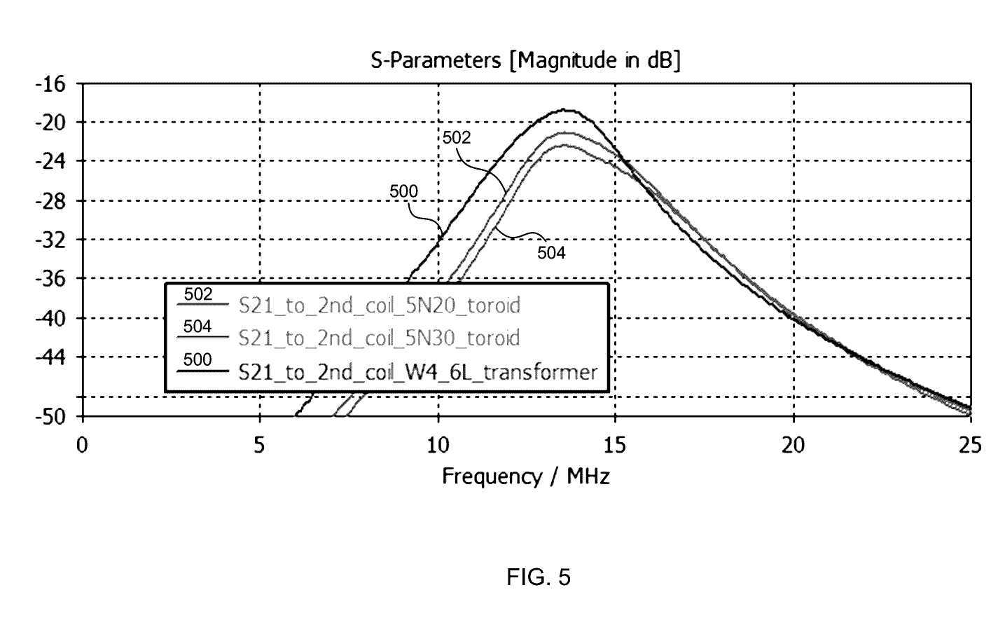

FIG. 5 is a graph of near field coupling performance of a single loop NFC antenna with respect to a second NFC antenna, for different transformers. As mentioned above it has been found that combining an impedance transformer with a single loop conductor enables a single loop NFC antenna to be created. Various different types of transformer may be used and FIG. 5 shows results of empirical testing of performance of different types of transformer in a single loop NFC antenna. The types of transformer for which results are shown in FIG. 5 include a commercially available Coilcraft (trade mark) WB4_6L transformer chip (see results line 500), a toroid coil transformer with 5 turns on a primary coil and 30 turns on a secondary coil (see results line 504), and a toroid coil transformer with 5 turns on a primary coil and 20 turns on a secondary coil (see results line 502). It is seen that near field coupling performance is better using a W4_6L transformer chip than using either toroid coil transformer in the frequency range 5 to 15 MHz. It is seen that of the two toroid coil transformers, the one having five turns on a primary coil and 20 turns on a secondary coil has better near field coupling performance at least in the range 6 to 16 MHz.

The empirical test results of FIG. 5 show that the impedance transformation ratio of the transformer, as well as the loss of the transformer, affect the overall performance of the single loop NFC antenna. In this empirical test set (shown in FIG. 5), W4_6L showed the smallest transmission loss of the tested transformers. The transmission loss may be reduced by providing an increased magnetic coupling between the primary and secondary coils of the transformer.

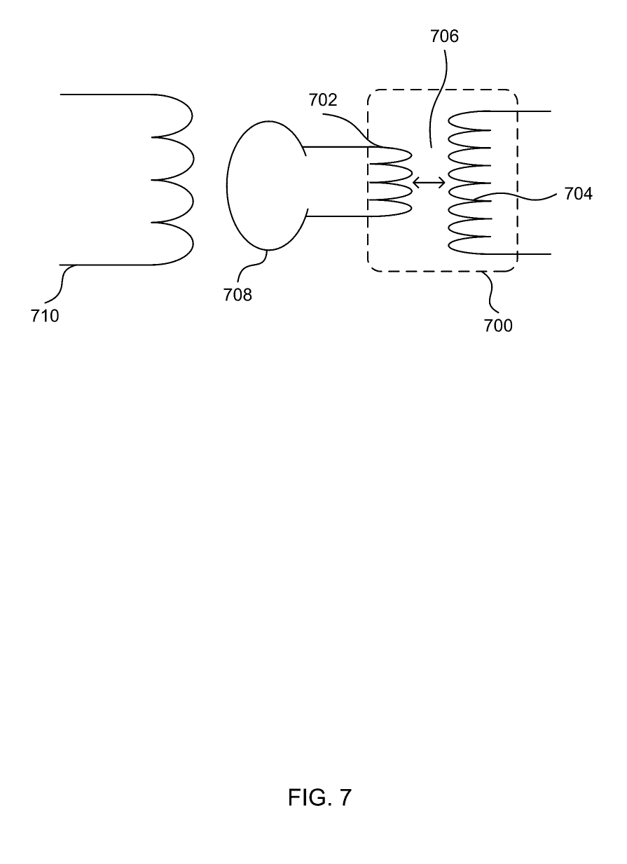

The number of turns in primary and secondary coils of the transformer together with the properties of the material of the core influence the usable frequency range of the transformer as explained below with reference to FIG. 7.

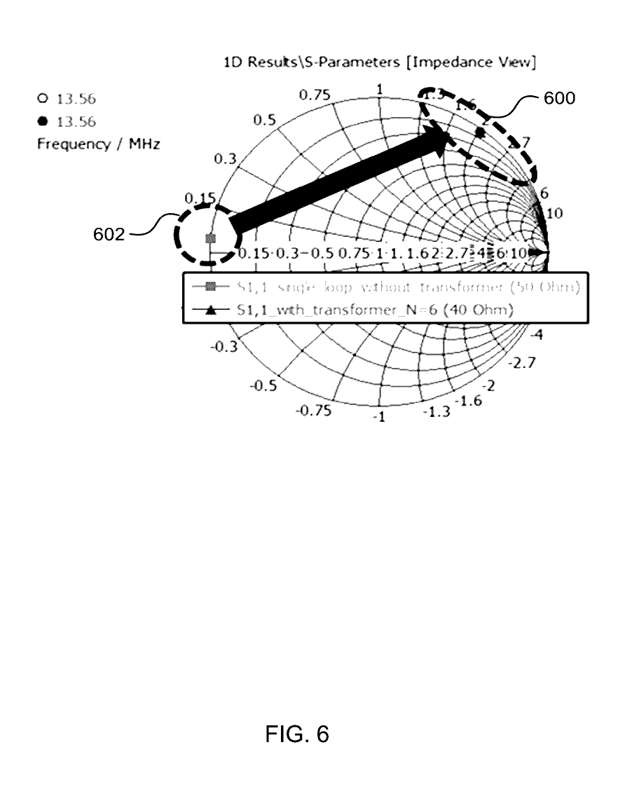

FIG. 6 is a Smith diagram illustrating shift of impedance of a simulation of a single loop NFC antenna as a result of adding a simulated transformer. Without the simulated transformer it is seen that the impedance is in range 602, that is, the impedance of the single conducting loop is acting similarly to a short circuit, and that when a simulated transformer is added the impedance shifts to range 600, showing an inductive reactance which is suitable for an antenna used for NFC communications. Once in the range 600 a matching circuit such as matching circuit 210 of FIG. 2 may further refine the impedance to match that of NFC circuitry 212.

As mentioned above it has been found that combining an impedance transformer with a single closed loop conductor enables a single loop NFC antenna to be created. Different types of transformer may be used such as: surface mount transformer, toroid transformer, coupled transformer coils etched on printed wiring board layers, hybrids of one or more of these types of transformer.

The transformer itself comprises a primary and a secondary coil (as shown schematically in FIG. 7). The secondary coil of the transformer is configured to be connected to the single loop conductor and is arranged to transform the impedance of the single loop conductor to a usable range for the NFC communication integrated circuit 212. In various examples, the inductance of the transformer secondary coil is close to the inductance of the single loop conductor in order to match currents effectively and improve efficiency. For example, the inductance of the secondary transformer coil may be less than 500 nH.

The primary coil of the transformer is magnetically connected to the secondary coil, for example, using a ferrite core which is shared by the primary transformer coil and the secondary transformer coil. For example, the magnetic coupling coefficient factor may be between 0.8 and 1.0 with respect to the magnetic coupling between the primary and secondary coils of the transformer. The inductance of the primary transformer coil may be between 0.8 and 2.0 μH so as to match the antenna system to the NFC circuitry 212. In various examples the ratio of the coil turns in the primary and secondary transformer coils is designed to bring the impedance of the single conducting loop to a usable range for NFC communications, preferably between 0.8 and 2.0 μH.

In some examples there is a method of operation of a near field communications antenna comprising applying power to a transformer which is connected to a single conductive loop, the single conductive loop being a loop without a plurality of turns or coils, such that a magnetic field generated in the transformer transforms the impedance of the single conductive loop into a range suitable for near field communications.

As mentioned above various different types of transformer 102 can be used and each of these types of transformer can be thought of as comprising a primary coil of conductor and a secondary coil of conductor configured so that a magnetic connection between the primary and secondary coils is established when current flows in the coils. FIG. 7 is a schematic diagram of an example transformer 700 comprising a primary transformer coil 704 and a secondary transformer coil 702 wound around a core 706. The transformer is magnetic in that a magnetic connection between the primary and secondary transformer coils is established, as indicated by the arrow. The core 706 may be made of ferrite or other magnetic material to facilitate the magnetic connection between the primary 704 and secondary 702 transformer coils. FIG. 7 also shows a schematic single loop conductor 708 connected to the transformer 700. A loop antenna 710 of a second near field communications device, such as device 214 of FIG. 2 is also shown.

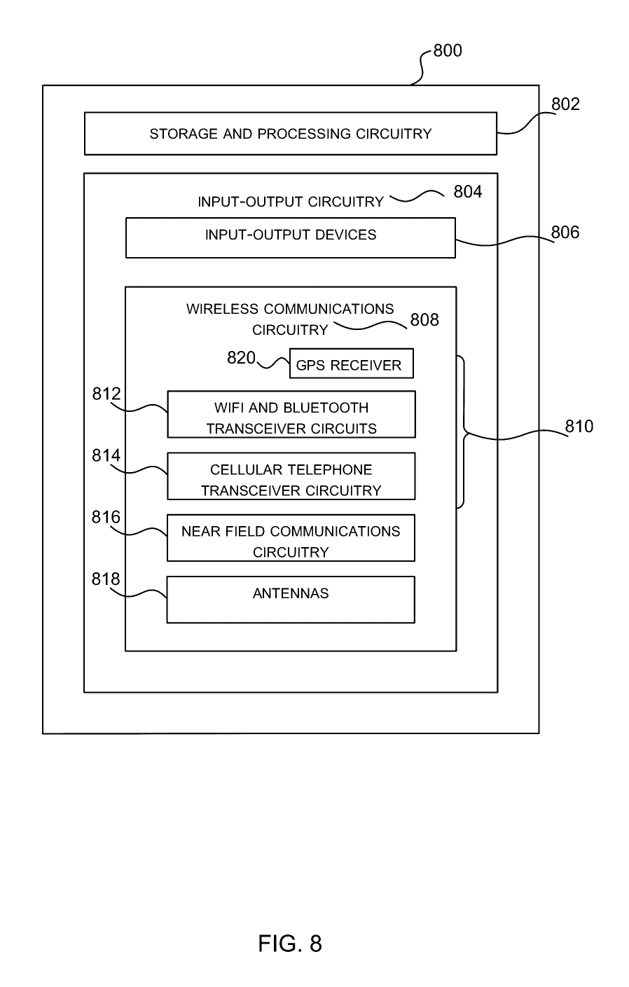

FIG. 8 is a schematic diagram of a communications device 800 comprising one or more antennas including a single loop NFC antenna as described herein. The communications device 800 is an example of a communications device implementing the mobile communications device 100 of FIG. 1 such as in the form of a smart phone, tablet computer or other mobile communications device.

The communications device 800 comprises control circuitry including storage and processing circuitry 802. Storage and processing circuitry 802 includes storage such as hard disk drive storage, nonvolatile memory (e.g. flash memory or other electrically-programmable read-only memory configured to form a solid state drive), volatile memory (such as static or dynamic random access memory). The storage and processing circuitry 802 comprises processing circuitry to control operation of the communications device 800. The processing circuitry comprises one or more microprocessors, microcontrollers, digital signal processors, baseband processors, power management units, audio codec chips, application specific integrated circuits and other components. The storage and processing circuitry 802 is able to run software on the computing device 800 such as interne browsing applications, voice over interne protocol applications, email applications, media playback applications, operating system functions and others. The storage and processing circuitry 802 may implement one or more communications protocols including NFC communication protocols, interne protocols, WLAN protocols, Bluetooth (trade mark) protocol, cellular telephone protocols and others.

The storage and processing circuitry 802 is configured to implement one or more control processes to control the user of one or more antennas in the communications device 800 such as a single loop NFC antenna and/or other types of antenna. The storage and processing circuitry 802 may be configured to perform signal quality monitoring and sensor monitoring and to use the monitored data to adjust one or more switches, tunable elements or other adjustable circuits in the device to adjust antenna performance. For example, to control which of two or more antennas is used to receive wireless communications, which antenna is used to transmit wireless communications, to control how incoming data is routed, to tune one or more of the antennas to different frequency bands, to perform multiplexing operations or demultiplexing operations, to share antenna structures between near field and non near field circuitry and others.

The communications device 800 comprises input-output circuitry 804 for enabling data to be input to the device 800 and to enable data to be output from the device 800. The communications device 800 comprises one or more input-output devices 806 such as a touch screen, button, microphone, speaker, tone generator, vibrator, camera, sensor, light emitting diode, status indicator, data port, joystick, click wheel, scroll wheel, touch pad, key pad, keyboard or others. A user is able to control operation of the device 800 by making input at one or more of the input-output devices. The input-output circuitry 804 and input output devices 806 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The communications device 800 has wireless communications circuitry 808 comprising radio frequency (RF) transceiver circuitry formed from one or more integrated circuits, power amplifier circuitry, low-noise amplifiers, passive RF components, one or more antennas 818 and other circuitry for handling RF wireless signals. Wireless signals can also be sent using infra-red or other electromagnetic signals.

The wireless communications circuitry 808 comprises optional global positioning system (GPS) receiver circuitry 820, optional WiFi (trade mark) and Bluetooth (trade mark) transceiver circuits 812, and cellular telephone transceiver circuitry 814. Near field communications circuitry 816 is included such as NFC circuitry 212 of FIG. 2.

One or more antennas 818 are included and comprise at least one single loop NFC antenna as described herein. The antennas 818 may be shared by non-near field communications circuitry 820, 812, 814 and near field communications circuitry 816. In addition to the at least one single loop NFC antenna, other antennas may be included such as antennas with resonating elements that are formed from a loop antenna structure, patch antenna structure, inverted F antenna structures, close and open slot antenna structures, planar inverted F antenna structures, helical antenna structures, strip antennas, monopoles, dipoles, and others. Different types of antennas may be used for different bands or combinations of hands.

In examples there is provided a near field communications antenna comprising a conductive loop connected to a transformer, the conductive loop having only one loop.

For example, the conductive loop is a closed loop comprising a continuous loop of conductor.

For example, the conductive loop is formed by the sides of a slot or aperture in a metal computing device case and the transformer connected to the slot or aperture.

For example, the conductive loop is formed by the sides of a slot in a metal computing device case and a short circuit or series inductor connected across the slot.

For example, the conductive loop is formed from a printed conductor and/or an etched trace on a flex.

For example, the slot or aperture is in a metal side face of a computing device case.

For example, the slot or aperture is in a metal side face of a computing device case and extends around a corner of the computing device case.

For example, the transformer is configured to bring the impedance of the antenna loop into a range that enables the conductive loop to act as a near field communications antenna.

For example, the transformer is magnetic.

For example, the transformer comprises a primary transformer coil and a secondary transformer coil the secondary transformer coil being connected to the single conductive loop and the primary and secondary transformer coils being magnetically connected.

For example, the secondary transformer coil has an inductance of less than 500 nH.

For example, the magnetic coupling coefficient factor between the primary and secondary transformer coils is from 0.7 to 1.0.

For example, the primary transformer coil transforms the inductance of the single conductive loop to a range from 0.8 to 2 μH.

For example, the primary transformer coil and the secondary transformer coil are supported on a shared ferrite core.

For example, the transformer is any of a surface mount transformer, a toroid transformer, coupled transformer coils etched on printed wiring board layers.

In some examples the antenna is part of an antenna structure configured for operation as a wireless antenna for cellular and/or complementary wireless system, CWS, wireless communications in addition to near field communications.

In an example there is a method of operation of a near field communications antenna comprising applying power to a transformer which is connected to a single conductive loop, the single conductive loop being a loop without a plurality of turns or coils, such that a magnetic field generated in the transformer transforms the inductance of the single conductive loop into a range suitable for near field communications.

For example, the range is any inductance of the single conductive loop less than 500 nH.

The method may comprise using a metal casing of a mobile communications device to form at least part of the single conductive loop.

In another example there is a near field communications antenna comprising a single conductive loop connected to a transformer, the single conductive loop being a loop without a plurality of turns or coils and wherein the inductance of the single conducting loop is less than 500 nH.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A near field communications antenna comprising a conductive loop connected to a transformer, the conductive loop having only one loop.

2. The near field communications antenna of claim 1 wherein the conductive loop is a closed loop comprising a continuous loop of conductor.

3. The near field communications antenna of claim 1 wherein the conductive loop is formed by the sides of a slot or aperture in a metal computing device case and the transformer connected to the slot or aperture.

4. The near field communications antenna of claim 1 wherein the conductive loop is formed by the sides of a slot in a metal computing device case and a short circuit or series inductor connected across the slot.

5. The near field communications antenna of claim 1 wherein the conductive loop is formed from a printed conductor and/or an etched trace on a flex.

6. The near field communications antenna of claim 3 wherein the slot or aperture is in a metal side face of a computing device case.

7. The near field communications antenna of claim 3 wherein the slot or aperture is in a metal side face of a computing device case and extends around a corner of the computing device case.

8. The near field communications antenna of claim 1 wherein the transformer is configured to bring the impedance of the antenna loop into a range that enables the conductive loop to act as a near field communications antenna.

9. The near field communications antenna of claim 1 wherein the transformer is magnetic.

10. The near field communications antenna of claim 1 wherein the transformer comprises a primary transformer coil and a secondary transformer coil the secondary transformer coil being connected to the single conductive loop and the primary and secondary transformer coils being magnetically connected.

11. The near field communications antenna of claim 10 wherein the secondary transformer coil has an inductance of less than 500 nH.

12. The near field communications antenna of claim 10 wherein the magnetic coupling coefficient factor between the primary and secondary transformer coils is from 0.7 to 1.0.

13. The near field communications antenna of claim 10 wherein the primary transformer coil transforms the inductance of the single conductive loop to a range from 0.8 to 2 μH .

14. The near field communications antenna of claim 10 wherein the primary transformer coil and the secondary transformer coil are supported on a shared ferrite core.

15. The near field communications antenna of claim 1 wherein the transformer is any of a surface mount transformer, a toroid transformer, coupled transformer coils etched on printed wiring board layers.

16. The near field communications antenna of claim 1 which is part of an antenna structure configured for operation as a wireless antenna for cellular and/or complementary wireless system, CWS, wireless communications in addition to near field communications.

17. A method of operation of a near field communications antenna comprising applying power to a transformer which is connected to a single conductive loop, the single conductive loop being a loop without a plurality of turns or coils, such that a magnetic field generated in the transformer transforms the inductance of the single conductive loop into a range suitable for near field communications.

18. A method as claimed in claim 17 wherein the range is any inductance of the single conductive loop less than 500 nH.

19. A method as claimed in claim 17 comprising using a metal casing of a mobile communications device to form at least part of the single conductive loop.

20. A near field communications antenna comprising a single conductive loop connected to a transformer, the single conductive loop being a loop without a plurality of turns or coils and wherein the inductance of the single conducting loop is less than 500 nH.
